(19) United States
(12) Patent Application Publication
(10) Pub. No.: US 2001/0037893 A1
(43) Pub. Date: Nov. 8, 2001

(54) Method and an arrangement relating to the encapsulation of a component

(76) Inventors: Roger Hoffstrom, Kista (SE); Carl Lars Eric Thorsell, Upplands Vasby (SE)

Correspondence Address: Rouzbeh Tabaddor, BURNS, DOANE, SWECKER & MATHIS, L.L.P., P.O. Box 1404, Alexandria, VA, 22313-1404, US

(21) Appl. No.: 09/761,826

(22) Filed: Jan. 18, 2001

Related U.S. Application Data
(63) Continuation of application No. 08/561,056, filed on Nov. 22, 1995, now abandoned.

(30) Foreign Application Priority Data
Sep. 7, 1995 (SE) 9503087-0

(51) Int. Cl. H02G 3/08

(52) U.S. Cl. 174/52.1

(57) ABSTRACT

With the intention of rendering a component impervious to washing liquid while preventing the occurrence of a pressure difference between the interior of the encapsulated component and outside the component, a small hole (6), a microhole, is formed in the component encapsulating casing. The provision of at least one such microhole in the casing encapsulate the component enables gas to flow through while preventing the throughflow of liquid. This permits a circuit board loaded with such encapsulated components to be washed. Practical tests and calculations have shown that an effective hole diameter in this regard is from 10-50 μm, for instance 30 μm, in order for the encapsulated component to be liquid impervious while unaffected by pressure. The diameter of the hole will depend on the use of the encapsulated component.

### TECHNICAL FIELD

The present invention pertains to a method relating to the encapsulation of a component and also to an arrangement relating to an encapsulated component, such as to protect the component against the ingress of washing liquid and to prevent the occurrence of a pressure difference between the pressure that prevails within the encapsulating casing of the component and its exterior. The invention may be applied in connection with the encapsulation of components that are to be mounted on circuit boards, such as encapsulated DC/DC converter modules.

### DESCRIPTION OF THE BACKGROUND ART

Encapsulated components, for instance DC/DC Power Modules, such as miniaturized DC/DC converters, that are to be mounted on circuit boards have been available for several years. Subsequent to having soldered the encapsulated components in their respective positions on a circuit board, it is necessary to wash the thus loaded circuit board with one of different types of aqueous washes. These washes may either have the form of multi-zone pure aqueous washes, or the form of semi-aqueous washes, wherein aggressive agents such as alcohols, turpentines or glycol ethers may be used as a solvent prior to a final rinse. The aqueous wash and the semi-aqueous wash have been developed as a result of terminating the use of freon for washing mounted circuit boards. On the other hand, the use of low-aggressive fluxes obviates the need to wash the circuit boards, although this alternative has not yet been fully accepted. Consequently, the semi-aqueous wash technique is often used in Europe, and then to an increasing extent, whereas solely the aqueous wash technique is used in the U.S.A. In the Asiatic countries, circuit boards are still washed with freon to a large extent.

With the abolishment of freon, the washing and rinsing liquids used to wash circuit boards loaded with encapsulated components is liable to remain within the encapsulating casing, and therewith cause serious problems. The casings in which such components are encased often function to increase the mechanical strength of these components, which form sub-circuit boards, and to enable the components to be handled more easily and also to relieve the load exerted by the incoming and outgoing pins.

There are two traditional ways of preventing the ingress of washing and rinsing liquid. One way is to encase the components in a liquid impervious casing, and the other is to fill the space enclosed by the casing with a plastic compound, for instance. When the encapsulation, or casing, is liquid-impervious, a certain amount of air will be enclosed in the casing, this air expanding as the components are soldered to the circuit board and therewith causing the casing to swell, particularly when surface soldering the components or when the components are subjected to heat in some other way. This swelling of the component casing, or encapsulation, may result in the electrical connection legs of the components being lifted away from their respective solder pads on the circuit board concerned. When a sealing adhesive is used to seal casing joints in the manufacture of the component, the enclosed air is liable to press out the adhesive as the sealing adhesive is baked, which is undesirable both from a technical and an aesthetic aspect. The method in which the space defined by the casing is filled with plastic compound has the drawback of being expensive. Furthermore, the plastic compound increases the weight of the component and is also able to increase the mechanical stresses on the components thus encapsulated. U.S. Pat. No. 5,334,799 teaches an electronic device enclosure which while preventing moisture from penetrating the enclosure permits enclosed gas to pass therethrough. To this end, an enclosure ventilation hole is provided with a gas-permeable, liquid-impervious sheet which includes a plurality of fine pores which while permitting air to pass therethrough prevent the ingress of moisture.

U.S. Pat. No. 5,081,327 teaches a microchip enclosure provided with ventilation means which allows gas to escape as the enclosure is heated, whereafter the enclosure is sealed.

### SUMMARY OF THE INVENTION

In accordance with the invention, a “microhole” of any desired shape is provided in the component casing, or encapsulation, when the component is encased or encapsulated in a manner to render the casing impervious to liquid and to prevent the occurrence of a pressure difference between the interior and exterior of the encapsulated component. The provision of at least one such microhole in the component casing or casing encapsulation will allow gas to pass through while preventing the ingress of liquid, thereby permitting a circuit board loaded with such encapsulated components to be washed. Practical tests and calculations have shown that the chosen diameter of such a microhole will depend partly on the area or field of use and will be from 10 to 50 μm. Such holes can be produced with the aid of a laser. The provision of said hole or holes in the component casing enables the casing joints to be sealed with an adhesive, the component therewith being impervious with regard to washing liquids but being able “to breathe” through the microhole, so that no pressure differences will prevail between the casing interior and exterior. The main function of the microhole is to cause the surface energy of the casing together with the surface tension of the liquid to repel the liquid, when the hole is sufficiently small. Thus, an encapsulated component which includes at least one microhole will be impervious to the washing liquid and will not be influenced by any pressure difference between the interior and exterior of the encapsulated component. Microholes of this nature have been used in other fields. For instance, such microholes are used in rainproof or shower-proof clothing which is required to be watertight but air-permeable. The aforementioned drawbacks are avoided by the provision of a microhole, while other drawbacks and limitations are non-existent. The microholes can also be formed at low cost. A functioning microhole can be formed with the aid of a laser in the space of 20 ms, provided that the casing or encapsulation is not thicker than about 1 mm. However, investment costs are higher when a laser and peripheral equipment are required to produce a large number of holes.

### BRIEF DESCRIPTION OF THE DRAWING

FIG. 1 is a partial cross-sectional view of an encapsulated circuit board component provided with a microhole in accordance with the invention.

FIG. 2 is an enlarged view of the microhole shown in FIG. 1.

### BEST MODE OF CARRYING OUT THE INVENTION

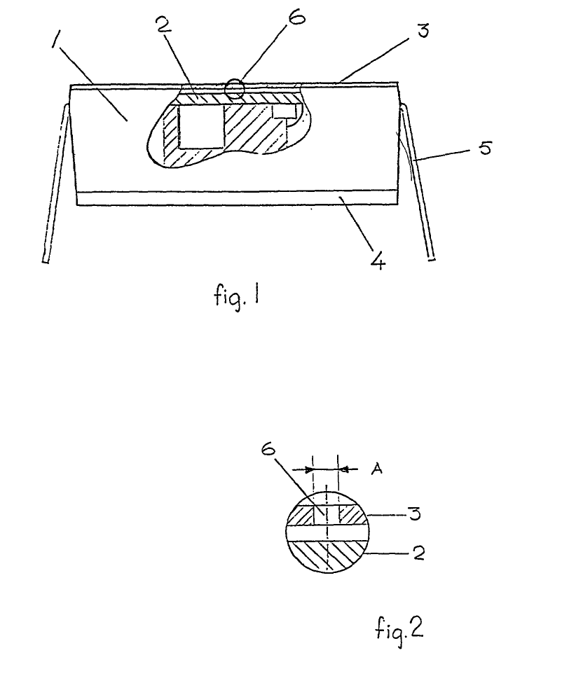

FIG. 1 illustrates an encapsulated, or encased electric component which is to be mounted on and soldered to the surface of a circuit board. The encapsulated component may include one or more circuits and entrapped air. The component casing 3, 4 is sealed with an adhesive or with weld.

The outwardly projecting contact legs 5 of the component are disposed for connection to points on or holes in the circuit board on which the component is to be mounted. The upper side 3 of the casing includes a microhole 6. A microhole having a diameter A of between 10-50 μm, for instance a diameter of 30 μm, enables gas to pass through, and therewith equalize the internal and external pressures, while preventing the ingress of moisture. Although only one microhole 6 is shown in the illustrated embodiment, it will be understood that the arrangement may include two or more microholes of any desired shape may be arranged in the casing of an encapsulated electronic component, in order to obtain the requisite imperviousness to washing liquid and a permitted gas through-flow, the number of holes in the arrangement being dependent on the application intended.

1. A method relating to the encapsulation of a component with the intention of rendering the encapsulated component liquid impervious and to prevent the occurrence of a pressure difference between the interior and the exterior of the encapsulated component, characterized by providing at least one microhole in the casing of the encapsulated component, such that the hole permits gas to pass through but prevents the through-passage of liquid.

2. A method according to claim 1, characterized in that the microhole or microholes has/have any desired shape and a diameter of between 10-50 μm, for instance a diameter of 30 μm.

3. An arrangement relating to the encapsulation of a component such as to render the encapsulated component liquid impervious and such as to prevent the occurrence of a pressure difference between the interior and the exterior of said encapsulated component, characterized in that the arrangement includes at least one microhole (6) in the casing (3) of the encapsulated component.

4. An arrangement according to claim 3, characterized in that the microhole (6) or the microholes has/have a desired shape and a diameter of between 10-50 μm, for instance a diameter of 30 μm.

5. A component provided with a casing, internal electronic circuit and wherein air may be trapped within the casing, said component being intended for mounting on a circuit board, characterized in that at least one microhole (6) is arranged in the casing (3) that encapsulates the component (1), such as to permit equalization of the pressures in the casing interior and externally of the casing, while preventing the ingress of liquid to the circuit (2) located within the casing.

6. A component according to claim 5, characterized in that the microhole (6) or the microholes has/have a desired shape and a diameter of between 10-50 μm, for instance a diameter of 30 μm.
